(19) United States
(12) Patent Application Publication
(10) Pub. No.: US 2022/0121665 A1
(43) Pub. Date: Apr. 21, 2022

(54) Computerized Methods and Systems for Selecting a View of Query Results

(71) Applicant: Authomize LTD, Tel Aviv (IL)

(72) Inventors: Gal DISKIN, Tel Aviv (IL); Ido Moshe, Giv'atayim (IL)

(21) Appl. No.: 17/073,358

(22) Filed: Oct. 18, 2020

(51) Int. Cl. G06F 16/2452; G06F 16/242; G06F 16/25

(52) U.S. Cl. CPC G06F 16/24522; G06F 16/252; G06F 16/24526; G06F 16/2445

(57) ABSTRACT

Computerized methods and systems retrieve a set of resources from at least one backend collection of resources in response to a resource query. Each resource has an associated backend resource type comprising one or more backend resource attribute. At least one view is identified, from a set of predefined views, that is satisfied by the retrieved set of resources. For each backend resource attribute of the retrieved set of resources, existence of a transformation between the backend resource attribute and a corresponding frontend attribute associated with the at least one view is verified in order to identify the at least one view. A selected view is selected from the identified at least one view based on a query intent derived at least in part from the resource query. A representation of the retrieved set of resources is generated according to the selected view.

### TECHNICAL FIELD

The present invention relates to information retrieval methods and systems.

### BACKGROUND OF THE INVENTION

Information retrieval systems are well known systems that retrieve information based on a resource query from one or more backend collections of resources and generate a representation of the retrieved resources to an end user or a client computer. In many conventional information retrieval systems, the representation of the retrieved resources is generic and is not tailored to specific characteristics or parameters such as the type and content of the query results and the intent expressed in the resource query.

### SUMMARY OF THE INVENTION

The present invention is directed to computerized methods and systems for selecting a view of query results and generating (rendering) a representation of the query results (retrieved set of resources) according to the selected view. The selection of the selected view of the query results is based at least in part on the type and content of the query results, and the intent expressed in the resource query used to retrieve the resources. In preferred embodiments, the selected view is selected by identifying a shortest path in a weighted graph composed of nodes representing a plurality of predefined views, query intentions, and other elements. This selected view is a “preferred view”, in that it is the view, given a resource query and corresponding query results, that best (i.e., optimally) represents the query results based on a plurality of criteria associated with the resource query and the query results (e.g., the intent expressed in the resource query, the backend resource types, the backend resource attributes, etc.).

The embodiments of the present invention rely on mappings between elements of the query results (backend attributes of the resource types of the query results) and frontend attributes of a set of predefined views in order to select the selected view and generate the representation of the query results according to the selected view. These mappings employ manipulations (i.e., transformations) of data objects, in particular transformations applied to values of backend attributes to produce corresponding frontend attribute values. The steps for selecting the selected view and generating the representation of query results (“a retrieved set of resources”) according to the selected view, including checking for existing mappings between backend attributes and frontend attributes, as well as applying transformations to values of backend attributes to produce corresponding frontend attribute values, are performed by a particular computer using various specialized computerized components (i.e., modules), embodying a computer system of the present invention.

Embodiments of the present invention are directed to a method performed by a computer. The method comprises: retrieving a set of resources from at least one backend collection of resources in response to a resource query, each resource having an associated backend resource type comprising one or more backend resource attribute; identifying at least one view from a set of predefined views that is satisfied by the retrieved set of resources, the identifying including, for each backend resource attribute of the retrieved set of resources, verifying existence of a transformation between the backend resource attribute and a corresponding frontend attribute associated with the at least one view; selecting a selected view from the identified at least one view based on a query intent derived at least in part from the resource query; and generating a representation of the retrieved set of resources according to the selected view.

Optionally, the identifying at least one view in the set of predefined views that is satisfied by the retrieved set of resources is based on a generated graph that includes: a first group of nodes representative of the set of predefined views, a second group of nodes representative of a set of display components associated with some of the predefined views in the set of predefined views, a third group of nodes representative of a set of frontend types associated with some of the display components in the set of display components, a fourth group of nodes representative of a set of frontend attributes associated with some of the frontend types in the set of frontend types, a fifth group of nodes representative of a set of backend resource attributes associated with some of the frontend attributes in the set of frontend attributes via a respective transformation, and a sixth group of nodes representative of a set of backend resource types including the backend resource type associated with each resource of the retrieved set of resources, the set of backend resource types associated with some of the backend resource attributes in the set of backend resource attributes.

Optionally, the identifying at least one view in the set of predefined views that is satisfied by the retrieved set of resources includes determining the existence of at least one linking connection between each of the predefined views in the set of predefined views and the backend resource type associated with each resource of the retrieved set of resources, each predefined view having an associated frontend attribute, and each existing linking connection including a transformation between each backend resource attribute of the backend resource type and a respective one of the frontend attribute.

Optionally, the method further comprises: analyzing the resource query to derive the query intent.

Optionally, the generating the representation of the retrieved set of resources according to the selected view includes: for each backend resource attribute of the retrieved set of resources, applying the transformation to a value of the backend resource attribute to produce a value of a corresponding frontend attribute, and generating a representation of at least one display component associated with the frontend attributes.

Optionally, the generating a representation of at least one display component associated with the frontend attributes includes: checking, for each display component, if at least one display condition of the display component is satisfied, and generating a representation of a particular display component only if at least one display condition of the particular display component is satisfied.

Optionally, the at least one backend collection of resources includes a database.

Optionally, the database includes a relational database.

Optionally, the database includes a non-relational database.

Optionally, the at least one backend collection of resources includes an object storage system.

Optionally, the at least one backend collection of resources includes a file system.

Optionally, the method further comprises: outputting the generated representation of the retrieved set of resources as at least one of at least one file or at least one byte stream, and the at least one file having a file format including one or more of: Portable Document Format (PDF), spreadsheet format, Hyper Text Markup Language (HTML) format, Extensible Markup Language (XML) format, plaintext format, JavaScript Object Notation (JSON) format, YAML Ain′t Markup Language (YAML).

Optionally, the method further comprises: sending the resource query to one or more backend collection of resources.

Optionally, the resource query is sent via a network.

Optionally, the resource query is received from a client computer prior to the computer retrieving the set of resources from the at least one backend collection of resources.

Embodiments of the present invention are directed to a computer system coupled to one or more backend collections of resources. The computer system comprises: a non-transitory computer readable storage medium for storing computer components; and a computerized processor for executing the computer components. The computer components comprise: a frontend interface including a query input interface and a result output interface, the query input interface configured to receive a resource query, a query executor configured to: receive the resource query from the query input interface, and in response to the received resource query, retrieve a set of resources from at least one of the backend collections of resources, each resource having an associated backend resource type comprising one or more backend resource attribute, a view selector configured to: identify at least one view from a set of predefined views that is satisfied by the retrieved set of resources, the identifying including, for each backend resource attribute of the retrieved set of resources, verifying existence of a transformation between the backend resource attribute and a corresponding frontend attribute associated with the at least one view, and select a selected view from the identified at least one view based on a query intent derived at least in part from the resource query, and a representation generator configured to: generate a representation of the retrieved set of resources according to the selected view, and provide the generated representation to the result output interface.

Optionally, the view selector is configured to identify at least one view in the set of predefined views that is satisfied by the retrieved set of resources based on a generated graph that includes: a first group of nodes representative of the set of predefined views, a second group of nodes representative of a set of display components associated with some of the predefined views in the set of predefined views, a third group of nodes representative of a set of frontend types associated with some of the display components in the set of display components, a fourth group of nodes representative of a set of frontend attributes associated with some of the frontend types in the set of frontend types, a fifth group of nodes representative of a set of backend resource attributes associated with some of the frontend attributes in the set of frontend attributes via a respective transformation, and a sixth group of nodes representative of a set of backend resource types including the backend resource type associated with each resource of the retrieved set of resources, the set of backend resource types associated with some of the backend resource attributes in the set of backend resource attributes.

Optionally, the view selector is configured to identify at least one view in the set of predefined views that is satisfied by the retrieved set of resources by: determining the existence of at least one linking connection between each of the predefined views in the set of predefined views and the backend resource type associated with each resource of the retrieved set of resources, each predefined view having an associated frontend attribute, and each existing linking connection including a transformation between each backend resource attribute of the backend resource type and a respective one of the frontend attribute.

Optionally, the computer components further comprise: an intent classifier configured to: receive the resource query from the frontend interface, analyze the resource query to derive the query intent.

Optionally, the representation generator is configured to generate the representation of the retrieved set of resources according to the selected view by: for each backend resource attribute of the retrieved set of resources, applying the transformation to a value of the backend resource attribute to produce a value of a corresponding frontend attribute, and generating a representation of at least one display component associated with the frontend attributes.

Optionally, the representation generator is configured to generate a representation of at least one display component associated with the frontend attributes by: checking, for each display component, if at least one display condition of the display component is satisfied, and generating a representation of a particular display component only if at least one display condition of the particular display component is satisfied.

Optionally, the at least one of the backend collections of resources is part of the computer system.

Optionally, the at least one of the backend collections of resources is separate from the computer system.

Optionally, the at least one of the backend collections of resources is coupled to the computer system via at least one of a network or an Application Programming Interface (API).

Optionally, the at least one of the backend collections of resources includes a database.

Optionally, the database includes a relational database.

Optionally, the database includes a non-relational database.

Optionally, the at least one of the backend collections of resources includes an object storage system.

Optionally, the at least one of the backend collections of resources includes a file system.

Optionally, the result output interface is configured to: receive the representation of the retrieved set of resources from the representation generator, and output the representation of the retrieved set of resources as at least one of at least one file or at least one byte stream, and the at least one file having a file format including one or more of: Portable Document Format (PDF), spreadsheet format, Hyper Text Markup Language (HTML) format, Extensible Markup Language (XML) format, plaintext format, JavaScript Object Notation (JSON) format, YAML Ain't Markup Language (YAML).

Optionally, the result output interface is further configured to: provide the at least one file to at least one of: a file system, an object storage system, a database, or a client computer.

Optionally, the query input interface is further configured to: receive the resource query from a client computer.

Optionally, the client computer is coupled to the computer system via a network.

Optionally, the result output interface is configured to: receive the representation of the retrieved set of resources from the representation generator, output the representation of the retrieved set of resources as at least one file, and provide the at least one file to the client computer via the network.

Embodiments of the present invention are directed to a method performed by a computer. The method comprises: retrieving a set of resources from at least one backend collection of resources in response to a resource query, each resource having an associated backend resource type comprising one or more backend resource attribute; processing the resource query and the retrieved set of resources to select a selected view from a set of predefined views based at least in part on: for each backend resource attribute of the retrieved set of resources, at least one transformation that maps the backend attribute to a frontend attribute associated with at least one predefined view in the set of predefined views, and a query intent, derived at least in part from the resource query, associated with at least one predefined view in the set of predefined view; and generating a representation of the retrieved set of resources according to the selected view.

Optionally, the at least one predefined view associated with the query intent, and the at least one predefined view associated with the frontend attributes, includes the selected view.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), virtual machines, and similar systems, workstations, modules and combinations of the aforementioned. The aforementioned “computer” may be in various types, such as a personal computer (e.g. laptop, desktop, tablet computer), or any type of computing device, including mobile devices that can be readily transported from one location to another location (e.g. smartphone, personal digital assistant (PDA), mobile telephone or cellular telephone).

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a non-limiting example environment in which a system according to an embodiment of the present disclosure can be deployed;

FIG. 2 is a block diagram representation of a resource, formed from backend resource types which are formed from backend attributes, that can be retrieved by the system of the present disclosure;

FIG. 3 is a block diagram representation of a non-limiting example of a resource having a single backend resource type having six backend attributes;

FIG. 4 is a diagram of the architecture of an exemplary system embodying the present disclosure;

FIG. 5 is a block diagram representation of a predefined view, formed from display components which are formed from frontend types which are formed from frontend attributes, that can be identified as a predefined view satisfied by a set of resources retrieved by the system of the present disclosure;

FIG. 6 is a block diagram representation of a non-limiting example of a predefined view having a single display component having a single frontend attribute having four frontend attributes;

FIG. 7 is graphical model composed of nodes representing predefined views, display components, frontend types, frontend attributes, backend types, and backend attributes, as well as edges that provide potential linking connections between some of the nodes, that can be used to identify predefined views satisfied by a set of resources retrieved by the system of the present disclosure;

FIG. 8 is a non-limiting example of a graph showing linking connections between nodes, generated according to the graphical model of FIG. 7;

FIG. 9 is a non-limiting example of a bi-partite graph composed of nodes representing predefined query intents and predefined views, and edges representing the affinity between the predefined query intents and the predefined views, generated according to a bi-partite graphical model that can be used to select a selected predefined view according to which a set of retrieved resources are to be represented by the system of the present disclosure;

FIG. 10 is a non-limiting example of a representation of a set of resources, retrieved by the system of the present disclosure, in which the representation is generated according to a selected predefined view by the system of the present disclosure, and in which the selection of the selected predefined view is performed by the system of the present disclosure;

FIG. 11 is a flow diagram illustrating a process for identifying satisfied views for query results, selecting a selected view from the satisfied views, and generating a representation of the query results according to the selected view, according to embodiments of the present disclosure;

FIG. 12 is a flow diagram illustrating a sub-process of the process of FIG. 11, for identifying all predefined views that are satisfied by a set of retrieved resources, according to embodiments of the present disclosure; and

FIG. 13 is a flow diagram illustrating a process for selecting a selected view from the satisfied views identified by the process of FIG. 12.

### DESCRIPTION OF THE PREFERRED EMBODIMENTS

The present invention is directed to computerized methods and systems for selecting a view of query results.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

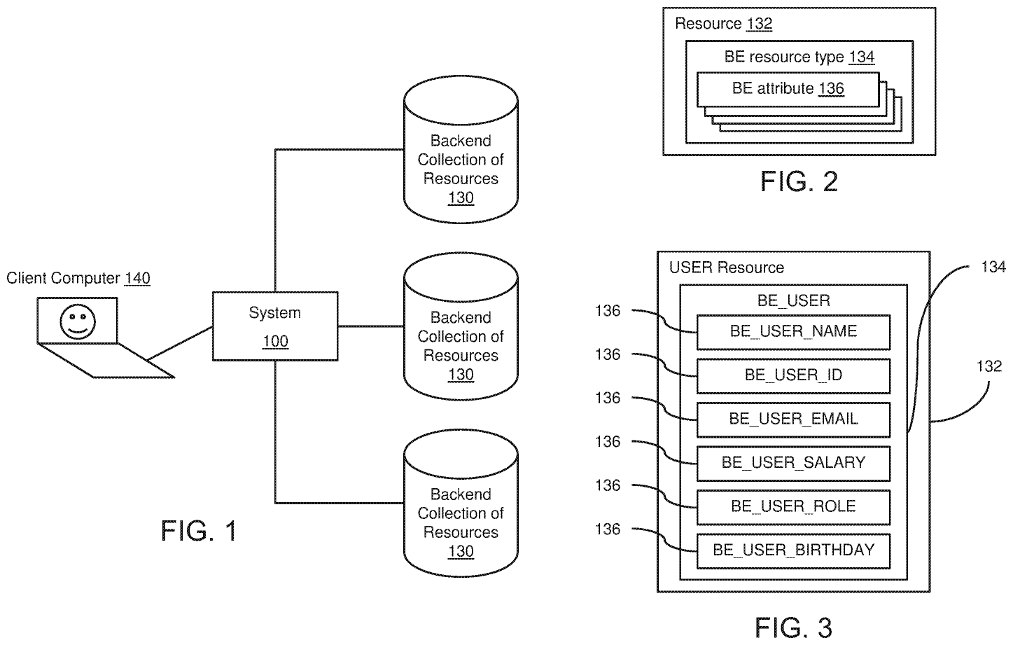

Reference is now made to FIG. 1, which shows an exemplary operating environment in which embodiments of the present disclosure may be performed. A computer system 100 (referred to hereinafter as “the system”), for selecting a view of query results and generating (rendering) a representation of the query results (retrieved set of resources) according to the selected view, is coupled (i.e., connected) to a client computer 140 and at least one computerized data store that stores collections of data, embodied herein as backend collections of resources 130. In the non-limiting example operating environment illustrated here, the client computer 140 and the backend collections of resources 130 are separate from the system 100, and may be coupled to the system via one or more networks, such as, for example, the Internet, cellular networks, wide area, public, and local networks. In such embodiments, the system 100 may be hosted by a server or server system coupled to the client computer 140 via the network or networks. The network or networks coupling the client computer 140 to the system 100 may be separate from the network or networks coupling the backend collections of resources 130 to the system 100. Alternatively, the backend collections of resources 130 may be coupled to the system 100 via one or more Application Programming Interface (API). In other embodiments, the system 100 may be integrated as part of the client computer 140. Further still, the one or more of the backend collections of resources 130 may be integrated as part of the system. In embodiments in which the client computer 140 is coupled to the system 100 via a network, the client computer 140 is representative of one of potentially many such client computers coupled to the system 100 via the same network or via one or more other networks.

As used herein, the term “coupled” includes both wired or wireless connection (communication links), either direct or indirect, so as to place computers and computer components, including client computers, computer systems, servers, data storage system, file systems, object storage systems, and the like, in electronic and/or data communication with each.

The backend collections of resources 130 are configured to store data (referred to as “resources”). The data may be stored in the backend collections of resources 130 using various technologies, including, but not limited to, relational databases, non-relational databases, object storage systems, file system storage, and the like.

In addition, the different backend collections of resources 130 need not be based on the same technology. For example, one of the backend collections of resources coupled to the system 100 could be implemented as a Structured Query Language (SQL) database (a well-known class of relational databases) for storing a collection of data, whereas another of the backend collections of resources coupled to the system 100 could be implemented as a file system for storing a collection of files, and yet another of the backend collections of resources coupled to the system 100 could be implemented as an object storage system for storing data objects.

Parenthetically, a single backend collection of resources could comprise an entire database/object storage system/file system, or could comprise only a subset of these. For example, a backend collection of resources could comprise a whole SQL database but could also comprise only a subset of the SQL tables stored in such a database.

Turning also to FIG. 2, there is shown the general structure of the resources 132 stored in the backend collections of resources 130. In general, each of the resources stored in the backend collections of resources 130 have the same type of generic structure shown in FIG. 2. As shown, each resource 132 has an associated backend (BE) resource type 134. Each backend resource type 134 comprises one or more backend attributes 136 (i.e., data points) about the resource type 134. The backend resource types 134 of the various resources 132 stored in the backend collections of resources 130 may be the same backend resource type or different backend resource types. For example, a first resource might represent a user in an organization and could therefore be associated with a backend resource type of BE_USER, a second resource might represent a group of users and could therefore be associated with a backend resource type of BE_USER_GROUP, a third resource might represent a written document and could therefore be associated with a backend resource type of BE_DOCUMENT, and so on.

It should also be appreciated that the resources within a single backend collection of resources need not be associated with the same backend resource type and that resources of the same backend resource type might be stored in more than one backend collection of resources.

Turning also to FIG. 3, there is shown a non-limiting illustrative example of a particular resource 132. In this example, the resource 132 represents a user in an organization (the resource 132 being labeled “USER Resource”) and has a backend resource type 134 of BE_USER. The backend resource type 134 of BE_USER includes the following backend attributes 136:
BE_USER_NAME
BE_USER_ID
BE_USER_EMAIL
BE_USER_SALARY
BE_USER_ROLE
BE_USER_BIRTHDATE

As mentioned, each of the backend collections of resources 130 could be coupled (i.e., connected) to the system 130. The coupling allows the system 130 to retrieve sets of resources and to optionally store resources within said backend collection of resources (i.e., a read and write capability). In preferred embodiments in which the backend collections of resources 130 are separate from the system 130, each of the backend collections of resources need not necessarily be co-located with the system 130. For example, in certain embodiments, one (or more) of the backend collections of resources 130 could be maintained by a third-party object storage provider, such as Amazon Simple Storage Service (S3) from Amazon Web Services (AWS), and the coupling of the system 130 to such a backend collection of resources could be provided using an API and/or a network protocol.

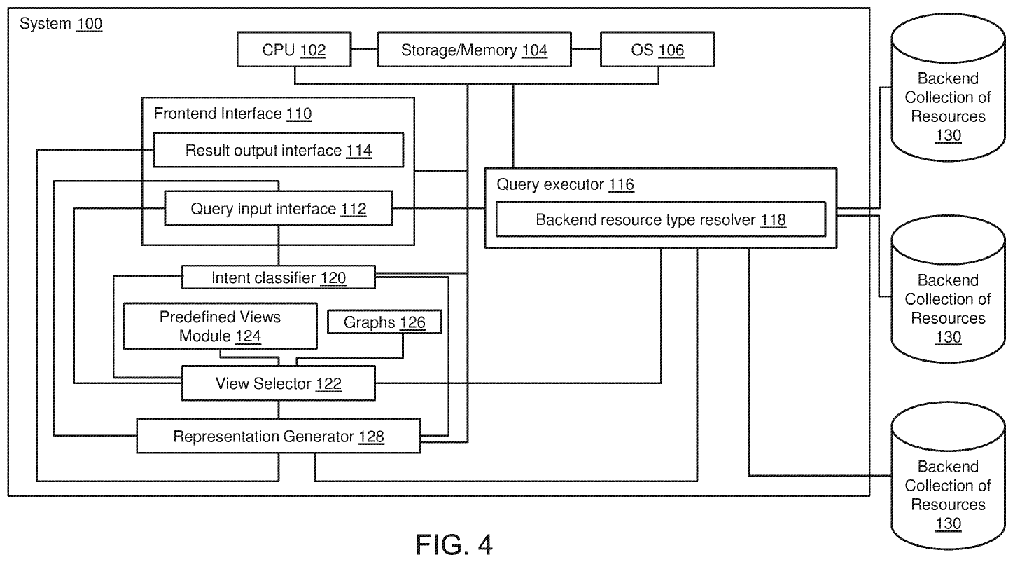

Turning now to FIG. 4, there is shown an exemplary system 100 as an architecture. The system 100 provides logic and logic functions for the invention. Generally speaking, the system 100 is configured to receive resource queries (for example from the client computer 140), execute the resource query, retrieve a set of resources from one or more of the backend collections of resources 130 (i.e., receive query results) in response to the query execution, select a selected view of query results, and generate a representation of the query results according to the selected view. The selected view is a “preferred view”, in that it is considered to be the “best” or “optimal view” for representing the retrieved set of sources, based on the content of retrieved resources and the intent expressed in the resource query.

The system 100 includes a central processing unit (CPU) 102 formed from one or more processors. The processors are, for example, conventional processors, such as those used in servers, computers, and other computerized devices. For example, the processors may include x86 Processors from AMD and Intel, Xeon® and Pentium® processors from Intel, as well as any combinations thereof.

The CPU 102 is electronically coupled (connected) to a storage/memory 104 for storing machine executable instructions, executable by the CPU 102, for performing the processes of the system 100, as will be detailed in subsequent sections of the present disclosure. The storage/memory 104, although shown as a single component for representative purposes, may be multiple components. The CPU 102 is also electronically coupled (connected), either directly or indirectly, to various modules (computer components) that are configured to perform the various logic functions of the invention. The CPU 102 is further electronically coupled (connected) to an operating system (OS) 106 that may load machine executable instructions, stored in the storage/memory 104, for execution by the CPU 102. The OS 106 may include any of the conventional computer operating systems, such as those available from Microsoft of Redmond Wash., commercially available as Windows® OS, such as Windows® 10, Windows® 7, MAC OS from Apple of Cupertino, Calif., or Linux, or may include real-time operating systems, or may include any other type of operating system typically deployed in sandboxed systems as known in the art.

The following paragraphs describe the various modules (computer components) of the system 100 that are configured to perform the various logic functions of the invention. The system 100 includes software, software routines, computer program code, computer program code segments and the like, embodied, for example, in computer components, modules and the like. These computer components, modules and the like of the system 100 generally include a frontend interface 110, a query executor 116, an intent classifier 120, a view selector 122, a module 124 for storing and retrieving predefined views (referred to hereinafter as a “predefined views module 124”) and for inputting the predefined views to the view selector 122, a module 126 for storing and retrieving one or more graphical models (referred to hereinafter as “graphs module 126”, and labeled in FIG. 4 as “Graphs 126”) and for inputting the graphical models to the view selector 122, and a representation generator 128.

The frontend interface 110 includes a query input interface 112 and a result output interface 114, and is configured to receive resource queries and provide the resource queries to the query executor 116. The query input interface 112 allows a user (e.g., a user of the client computer 140, a user of the system 100, etc.) to provide a resource query as input to the system 100. In certain embodiments, the user may provide the resource query to the query input interface 112 via the client computer 140. In other embodiments, the user may directly provide the resource query to the query input interface 112, for example, in embodiments in which the system 100 is integrated as part of the client computer 140. The user may provide the resource query to the query input interface 112 using any one of well-known input techniques, including, for example, via one or more peripheral devices connected to the system 100 or the client computer 140, such as, for example, a keyboard, a mouse, a microphone, a camera, and the like. In certain embodiments, the query input interface 112 is configured to support an API for inputting the resource query.

The resource query that is input to the system 100 via the query input interface 112 is used to express the set of resources that are to be retrieved from the backend collections of resources 130. In general, the resource query can be expressed in a domain specific query language, such as SQL or any one of its variants, and/or using a natural language, such as English, Spanish, French, Swedish, and the like.

The resource query is preferably associated with a requestor identity that identifies the user or entity that inputs the resource query to the system 100 via the query input interface 112. In certain preferred embodiments, the frontend interface 110 establishes the requestor identity by, for example, authenticating the user or the client computer from which the resource query originated. The frontend interface 110 may establish the requestor identity in response to receiving the resource query from a client computer (e.g., the client computer 140). Alternatively, the requestor identity may be identified prior to the receipt of the resource query by the frontend interface 110. Upon receiving a resource query, the system 100 may optionally store the resource query and the associated requestor identity in a memory, such as the storage/memory 104, in a relational format so as to relate the resource query with its associated requestor identity.

The result output interface 114 outputs a representation (i.e., a rendering) of the set of resources retrieved from the backend collections of resources 130 in response to the received resource query. This set of resources retrieved from the backend collections of resources 130 is referred to in this disclosure and appended claims interchangeably as the “set of retrieved resources” or the “retrieved set of resources”. The result output interface 114 is preferably configured to output the representation of the retrieved set of resources in various formats, including as one or more files. The one or more files may be of the same or different file formats, including, but not limited to, Portable Document Format (PDF), spreadsheet format, Hyper Text Markup Language (HTML) format, Extensible Markup Language (XML) format, plaintext format, JavaScript Object Notation (JSON) format, YAML Ain′t Markup Language (YAML) format, and the like. In certain embodiments, the result output interface 114 outputs the representation of the retrieved set of resources as one or more files to be sent to a client computer (such as the client computer 140) over a network, to be written to a file system, an object storage system, or a database (relational or non-relational), or any combination thereof.

The query executor 116 is coupled to the frontend interface 110, in particular the query input interface 112, and is configured to receive the resource query from the query input interface 112. In certain embodiments, the query executor 116 provides the coupling at the system 110 to the backend collections of resources 130. The query executor 116 is configured to execute the resource query received from the query input interface 112, and to retrieve a set of resources associated with the resource query from one or more of the backend collections of resources 130 in response to the query execution.

The query executor 116 preferably includes a backend resource type resolver 118 that determines, for each retrieved resource in the set of retrieved resources, the backend resource type associated with the retrieved resource. The backend resource type resolver 118 may determine the backend resource type in various ways. In certain non-limiting embodiments, the determination is based on the backend collection(s) of resources from which the retrieved resource was retrieved, metadata that is retrieved together with the set of retrieved resources, and the content (e.g., values) of the retrieved resources. For example, the backend resource type resolver 118 may associate a resource retrieved from an SQL table named USERS as having a backend resource type of BE_USER. In this example, the backend resource type resolver 118 resolves the backend resource type based on a preconfigured setting indicating that all resources retrieved from this table should be associated with the backend resource type of BE_USER. As another example, a file retrieved from a file system with a file extension of a “.jpg”, “.png”, “.bmp”, or “.gif” could be associated with a backend resource type of BE_PICTURE. In this example, the backend resource type resolver 118 resolves the backend resource type based on a preconfigured mapping between different file extensions (suffix names) and their corresponding backend resource type. As another example, another file could be determined to be of a backend resource type of XML based on the content of the retrieved resource. It should be appreciated that content-based backend resource type determination could be implemented, for example, using techniques similar to those employed by the well-known “file” UNIX™ command. Alternatively, resource content-based backend type determination could be implemented, for example, using a Machine Learning model.

After determining the backend resource type of each resource of the set of retrieved resources, the query executor 116 preferably employs the backend resource type resolver 118 to associate the determined backend resource types with each corresponding resource in the set of retrieved resources.

The intent classifier 120 is coupled to the frontend interface 110 and is configured to receive the resource query from the query input interface 112. In addition, the intent classifier is preferably configured to receive from the frontend interface 110 the requestor identity, that is associated with the resource query, that is, for example, established by the frontend interface 110. The intent classifier 120 analyzes the received input (i.e., the resource query and optionally the requestor identity) to derive a query intent associated with the resource query. The intent classifier 120 may be configured to analyze the resource query to extract keywords from the resource query so as to derive the query intent. In certain non-limiting exemplary implementations, the intent classifier 120 is implemented using a machine learning model/algorithm that analyzes/processes the received input according to the machine learning model. The machine learning model may be, for example, a supervised machine learning model, that is trained over a set of input/output samples that include sample input resource queries (and optionally requestor identities) and corresponding sample expected query intent outputs.

As an example, the intent classifier 120 may classify the natural English-language resource query “Retrieve all suspicious files executed within the last hour” as having a query intent related to “Information Security”. As a further example, the intent classifier 120 may classify the SQL resource query “SELECT * FROM PAYMENTS” as having a query intent related to “Finance”.

The view selector 122 is coupled to the frontend interface 110, the query executor 116, the intent classifier 120, the predefined views module 124, and the graphs module 126. The view selector 122 selects a selected view (a “preferred view”) out of a set of predefined views based on the content of retrieved resources and the intent expressed in the resource query, as defined by inputs received by the view selector 122 from one or more of: the frontend interface 110, the query executor 116, the intent classifier 120, the predefined views module 124, and the graphs module 126. In particularly preferred embodiments, the view selector 122 receives as input: i) the resource query from the query input interface 112, ii) the set of retrieved resources associated with the resource query from the query executor 116 as well as the associated backend resource types from the backend resource type resolver 118, iii) the query intent from intent classifier 120, iv) a set of predefined views from the predefined views module 124, and v) at least one graphical model from the graphs module 126.

The set of predefined views are preferably stored and maintained by the system 100 (for example stored in the storage/memory 104), and can be defined, for example, by a system administrator. In certain embodiments, the predefined views can be periodically modified or updated by an administrator to remove some of the predefined views, include new predefined views, and/or modify one or more the component/element of one or more predefined view. Generally speaking, each predefined view provides a structure or template for a representation (rendering) of the data (i.e., resources) retrieved from the backend collections of resources 130. The representations may include various display components, such as data tables, text windows/boxes (both editable and non-editable), column headers, tabs, drop-down menus, dashboard data, and the like. The representation may be a visual representation that can be viewed by a user (i.e., a user of the system 100 such as a user of the client computer 140). Alternatively, the representation may be a non-visual representation that is consumed or processed by an unattended computer system.

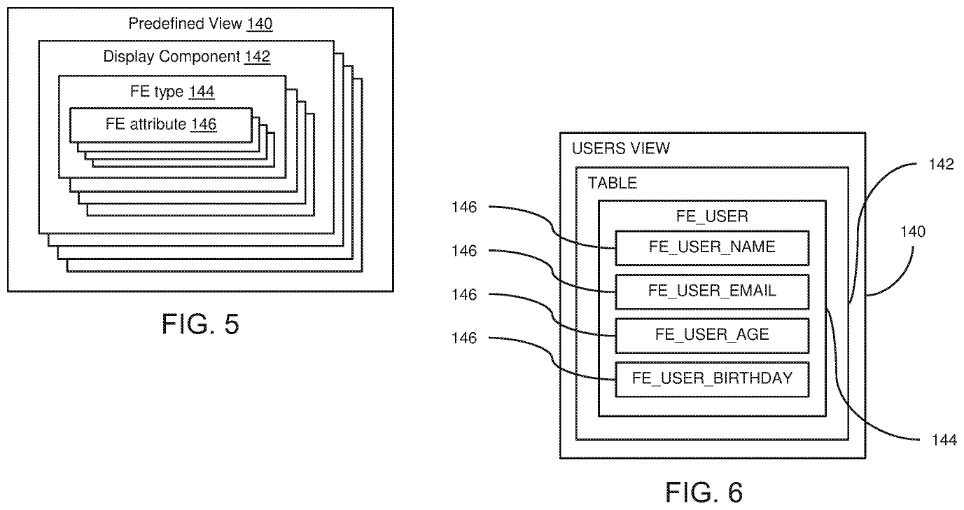

Turning also to FIG. 5, there is shown the general structure of the predefined views. In general, each of the predefined views 140 in the set of predefined views received from the predefined views module 124 have the same type of generic structure shown in FIG. 5. As shown, each predefined view 140 includes at least one display component 142. In preferred but non-limiting implementations, each display component is used to render information related to at least one resource in the set of retrieved resources. Each display component 142 includes at least one frontend (FE) type 144. Each frontend type 144 includes at least one frontend (FE) attribute 146. As will be discussed in further detail below, each backend attribute 136 is preferably mapped to zero or more frontend attributes 146 using a predefined transformation.

In certain embodiments, some or all of the display components 142 include at least one display condition (i.e., each display component 142 includes zero or more display conditions). As will be discussed in further detail below, each display condition provides a specific condition under which the display component (having the particular display condition) should have a representation generated by the representation generator 128. The display conditions are preferably based on the requestor identity and/or the derived query intent.

Turning also to FIG. 6, there is shown a non-limiting illustrative example of a particular predefined view 140 that can be used to represent “users” (e.g., USERS VIEW). Here, the predefined view 140 consists of a single display component 142 in the form of a table having table entries of the frontend type 144 of FE_USER, which includes the following frontend attributes 146:
FE_USER_FIRST_NAME
FE_USER_EMAIL
FE_USER_AGE
FE_TODAY_BIRTHDAY

As mentioned, each backend attribute 136 is preferably mapped to zero or more frontend attributes 146 using a predefined transformation. For example, in the examples illustrated in FIG. 3 and FIG. 6, the backend attribute 136 BE_USER_BIRTHDAY (FIG. 3) can be mapped to the frontend attribute 146 FE_USER_AGE (FIG. 6) using a transformation that takes as inputs the BE_USER_BIRTHDAY value and the current date to compute the current user age and assigns the current age value to the FE_USER_AGE. As another example, the same BE_USER_BIRTHDATE backend attribute could be mapped to the frontend attribute FE_TODAY_BIRTHDAY (FIG. 6) using another predefined transformation which takes as inputs the BE_USER_BIRTHDAY value and the current date to output a true/false value (e.g., TRUE if the current date is the user's birthday, and FALSE if the current date is not the user's birthday) assigned to FE_TODAY_BIRTHDAY.

Given a set of retrieved resources (and their respective backend resource types 134), the view selector 122 identifies all predefined views 140 that are satisfied by the set of retrieved resources. These so called “identified views” may be referred to interchangeably as “identified predefined views”, “satisfied views”, and “satisfied predefined views”. The view selector 122 may perform the identification of the satisfied (identified) views by using the set of predefined views received from the predefined views module 124 and one or more graphical models received from the graphs 126.

Generally speaking, for a set of retrieved resources, designated R, a predefined view 140 is determined to be satisfied by R if all of the display components 142 of the predefined view 140 are satisfied by R. A display component 142 is determined to be satisfied by R if all of the frontend types 144 of the display component 142 are satisfied by R. A frontend type 144 is determined to be satisfied by R if all of the frontend attributes 146 of the frontend type 144 are satisfied by R. A frontend attribute 146 is determined to be satisfied by R if there exists at least one predefined transformation that maps a backend attribute 136 that is satisfied by R to the frontend attribute 146. A particular backend attribute 136 is determined to be satisfied by R if the particular backend attribute 136 is part of a resource type 134 associated with the backend resources in R (i.e., if the backend resource type 134 associated with the backend resources in R includes the particular backend attribute 136).

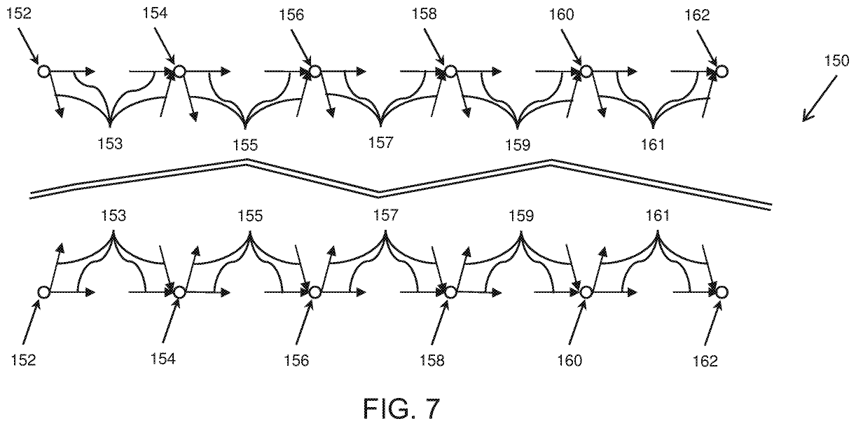

In certain embodiments, the view selector 122 employs a graphical model, provided to the view selector 122 by the graphs module 126, to identify all predefined views that satisfy a set of retrieved resources. FIG. 7 shows an example of a trellis-type graphical model 150 that includes multiple sets (groups) of nodes and multiple sets (groups) of edges. The sets (groups) of nodes include: nodes 152 representing predefined views 140, nodes 154 representing display components 142, nodes 156 representing frontend types 144, nodes 158 representing frontend attributes 146, nodes 160 representing backend attributes 136, and nodes 162 representing resource types 134. The sets (groups) of edges include: edges 153 providing a linking connection between some of the nodes 152 and some of the nodes 154, edges 155 providing a linking connection between some of the nodes 154 and some of the nodes 156, edges 157 providing a linking connection between some of the nodes 156 and some of the nodes 158, edges 159 providing a linking connection between some of the nodes 158 and some of the nodes 160, and edges 161 providing a linking connection between some of the nodes 160 and some of the nodes 162. A particular edge exists between a pair of nodes (i.e., connects between a pair of nodes) if the entity/object represented by one of the nodes is satisfied by the entity/object represented by the other of the nodes. For example, an edge in the set of the edges 153 exists between a particular one of the nodes 152 and a particular one of the nodes 154 if the predefined view representative of the particular one of the nodes 152 is satisfied by the display component representative of the particular one of the nodes 154.

A particular edge 159 exists between a node 158 (a frontend attribute 146) and a node 160 (a backend attribute 136) if there is a predefined transformation that maps the backend attribute 136 to the frontend attribute 146. Such a transformation (i.e., manipulation) provides a mapping between the particular backend attribute data object (i.e., value, data point) and a corresponding frontend attribute data object (i.e., value, data point). In other words, in response to receiving a backend attribute data object (i.e., value, data point) as input, the transformation generates as output a corresponding frontend attribute data object (i.e., value, data point). The predefined transformations may include, for example, formulaic computations (e.g., date calculations, salary calculations, etc.), application of binary logic to backend attributes, the identity function, decryption or encryption functions, string manipulation, or a combination thereof. In certain preferred embodiments, the mappings are one-to-one, such that each backend attribute data object is mapped to a single frontend attribute data object (and vice versa).

In certain embodiments, the view selector 122 may be configured to construct/generate a graph using the graphical model provided by the graphs module 126, and then identify the predefined views that satisfy the set of retrieved resources using the constructed graph and simple graph theory algorithms/techniques.

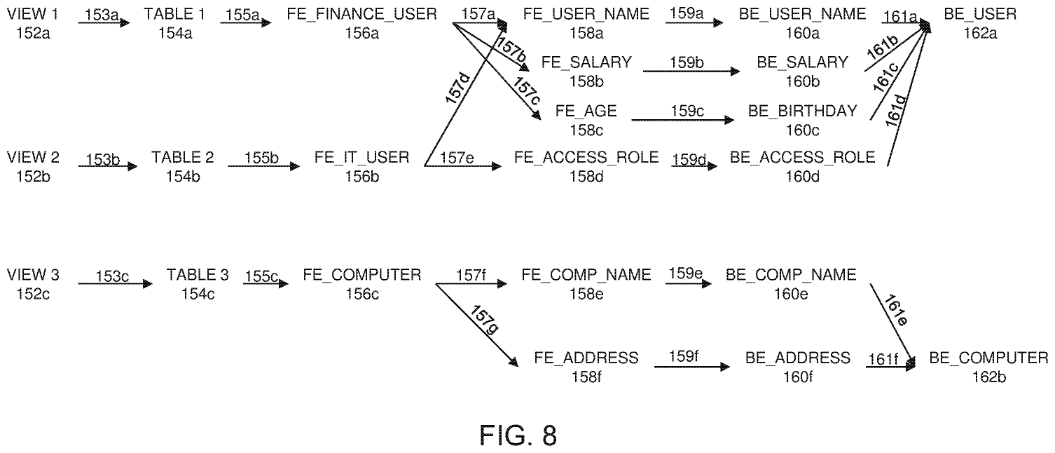

FIG. 8 shows an illustrative example of a graph for a non-limiting example case of three predefined views potentially connected to two backend resource types. It is noted that this example is particularly simplistic in terms of the number of predefined views and backend resource types, as well as the number of intermediate nodes that provide the potential linking connection between the predefined views and the backend resource types. While the example graph illustrated in FIG. 8 is simplistic in nature in order to aid in the description of the operation of the system 100, in practice the system 100 may employ graphs having anywhere between ten and a few hundred nodes in each set (group) of nodes.

Three nodes, designated 152a, 152b and 152c, represent three respective predefined views, labeled VIEW 1, VIEW 2 and VIEW 3. VIEW 1 has a single display component, labeled TABLE 1, that is represented by node 154a. A linking connection between nodes 152a and 154a is provided by edge 153a. VIEW 2 has a single display component, labeled TABLE 2, that is represented by node 154b. A linking connection between nodes 152b and 154b is provided by edge 153b. VIEW 3 has a single display component, labeled TABLE 3, that is represented by node 154c. A linking connection between nodes 152c and 154c is provided by edge 153c.

The display component TABLE 1 has a single frontend type, labeled FE_FINANCE_USER, that is represented by node 156a. A linking connection between nodes 154a and 156a is provided by edge 155a. The display component TABLE 2 has a single frontend type, labeled FE_IT_USER, that is represented by node 156b. A linking connection between nodes 154b and 156b is provided by edge 155b. The display component TABLE 3 has a single frontend type, labeled FE_COMPUTER, that is represented by node 156c. A linking connection between nodes 154c and 156c is provided by edge 155c.

The frontend type FE_FINANCE_USER has three frontend attributes, labeled FE_USER_NAME, FE_SALARY and FE_AGE, represented by nodes 158a, 158b and 158c, respectively. A linking connection between nodes 156a and 158a is provided by edge 157a. A linking connection between nodes 156a and 158b is provided by edge 157b. A linking connection between nodes 156a and 158c is provided by edge 157c.

The frontend type FE_IT_USER has two frontend attributes, labeled FE_USER_NAME (attribute shared with FE_FINANCE_USER) and FE_ACCESS_ROLE, represented by nodes 158a and 158d, respectively. A linking connection between nodes 156b and 158a is provided by edge 157d. A linking connection between nodes 156b and 158d is provided by edge 157e.

The frontend type FE_COMPUTER has two frontend attributes, labeled FE_COMP_NAME and FE_ADDRESS, represented by nodes 158e and 158f, respectively. A linking connection between nodes 156c and 158e is provided by edge 157f. A linking connection between nodes 156c and 158f is provided by edge 157g.

Looking now at the various frontend attributes, FE_USER_NAME is mapped to a single backend attribute, labeled BE_USER_NAME (represented by node 160a). A linking connection between nodes 158a and 160a is provided by edge 159a. The frontend attribute FE_SALARY is mapped to a single backend attribute, labeled BE_SALARY (represented by node 160b). A linking connection between nodes 158b and 160b is provided by edge 159b. The frontend attribute FE_AGE is mapped to a single backend attribute, labeled BE_BIRTHDAY (represented by node 160c). A linking connection between nodes 158c and 160c is provided by edge 159c. The frontend attribute FE_ACCESS_ROLE is mapped to a single backend attribute, labeled BE_ACCESS_ROLE (represented by node 160d). A linking connection between nodes 158d and 160d is provided by edge 159d. The frontend attribute FE_COMP_NAME is mapped to a single backend attribute, labeled BE_COMP_NAME (represented by node 160e). A linking connection between nodes 158e and 160e is provided by edge 159e. The frontend attribute FE_ADDRESS is mapped to a single backend attribute, labeled BE_ADDRESS (represented by node 160f). A linking connection between nodes 158f and 160f is provided by edge 159f.

In the example illustrated in FIG. 8, the linking connections between the frontend attributes and the backend attributes, provided by the edges 159a-159f, include mappings between the backend attribute data objects and the frontend attribute data objects.

The backend attributes BE_USER_NAME, BE_SALARY, BE_BIRTHDAY and BE_ACCESS_ROLE are all part of the same backend resource type BE_USER (represented by node 162a). The linking connection between the node 162a and each of the nodes 159a, 159b, 159c and 159d is provided by respective edges 161a, 161b, 161c and 161d. The edges 161a, 161b, 161c and 161d (i.e., the linking connections) are representative of the backend attributes BE_USER_NAME, BE_SALARY, BE_BIRTHDAY and BE_ACCESS_ROLE being part of the same backend resource type BE_USER.

Similarly, the backend attributes BE_COMP_NAME and BE_ADDRESS are both part of the same backend resource type BE_COMPUTER (represented by node 162b). The linking connection between the node 162b and each of the nodes 159e and 159f is provided by respective edges 161e and 161f. The edges 161e and 161f (i.e., the linking connections) are representative of the backend attributes BE BE_COMP_NAME and BE_ADDRESS being part of the same backend resource type BE_COMPUTER.

In the example illustrated in FIG. 8, VIEW 1 and VIEW 2 are satisfied by resource type USER, while VIEW 3 is satisfied by resource type COMPUTER. Accordingly, the view selector 122, in response to receiving a set of retrieved resources having backend resource type USER, would identify VIEW 1 and VIEW 2 as being satisfied by the set of retrieved resources.

The view selector 122 is configured to select the selected view from all of the identified predefined views that are satisfied by the set of retrieved resources. The selection is based on identifying the identified predefined view for which the particular query intent (associated with the resource query) has the best (i.e., optimal) affinity. In certain preferred embodiments, the affinity between query intents and the predefined views is represented using another graphical model—in the form of a bi-partite graph—provided by the graphs module 126, that provides a linking connection between the predefined views and predefined query intents. The bi-partite graph (also referred to as an “intent2view graph”) includes a first set of nodes representing the set of predefined query intents, a second set of nodes representing a set of predefined views, and a set of edges providing a linking connection between each one of the nodes and each one of the nodes.

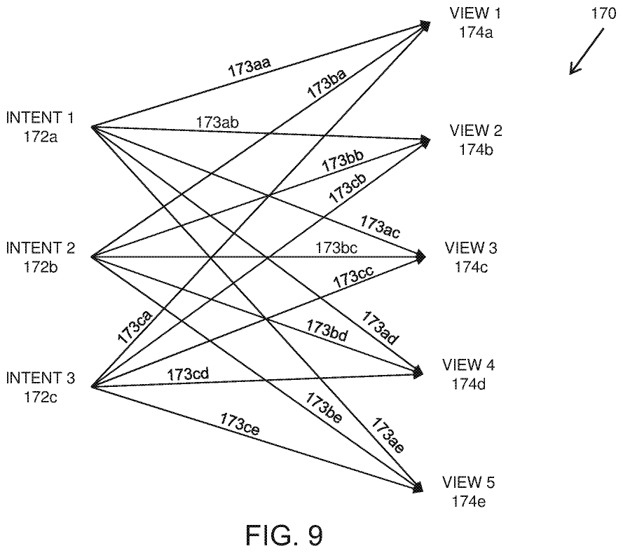

FIG. 9 shows an example of such a bi-partite graph 170, having a first set of nodes composed of nodes 172a, 172b and 172c representing the set of predefined query intents composed of the three query intents labeled INTENT 1, INTENT 2 and INTENT 3, a second set of nodes 174a, 174b, 174c, 174d and 174e representing the set of predefined views composed of the five predefined views labeled VIEW 1, VIEW 2, VIEW 3, VIEW 4 and VIEW 5, and a set of fifteen edges 173aa, 173ab, 173ac, 173ad, 173ae, 173ba, 173bb, 173bc, 173bd, 173be, 173ca, 173cb, 173cc, 173cd and 173ce providing a linking connection between each one of the nodes 172a, 172b and 172c and each one of the nodes 174a, 174b, 174c, 174d and 174e.

As with the graph in FIG. 8, the example graph illustrated in FIG. 9 is simplistic in nature in order to aid in the description of the operation of the system 100, and in practice the system 100 may employ bi-partite graphs having anywhere between two and a few hundred nodes of each of the query intent nodes and the predefined view nodes.

Each of the aforementioned edges between the nodes has an associated affinity metric, such as a distance or a weight. The value of the metric for a given edge represents the affinity of the specific predefined query intent and the linked predefined view. For example, a predefined query intent of “Finance” is likely to have an edge with a short distance (or small weight) connecting to a predefined view whose purpose is to serve users from the finance department of an organization, and at the same time is likely to have an edge with a long distance (or large weight) connecting to a predefined view whose purpose is to serve users from the IT department.

Parenthetically, the set of predefined query intents are preferably stored and maintained by the system 100 (for example stored in the storage/memory 104), and can be defined, for example, by a system administrator. In certain embodiments, the predefined query intents can be periodically modified or updated by an administrator to remove some of the predefined query intents or to include new predefined query intents. Preferably, the set of predefined query intents includes all (or substantially all) of the query intents that can be derived by the intent classifier 120 in response to processing a resource query (and optionally the requestor identity). In addition, the system 100 may maintain the linking connection between each predefined query intent and each predefined view (for example, as a bi-partite graph stored in the graphs module 126), and may update the linking connections (i.e., update/modify the value of the affinity metric between the predefined query intents and the predefined views).

In response to identifying the predefined views that are satisfied by the set of retrieved resources (i.e., determining the identified views), the view selector 122 may identify all the nodes in the bi-partite graph that represent the identified predefined views, and may then identify the node in the bi-partite graph that represents the particular derived query intent. The view selector 122 may then select, from the identified predefined views, the view that has the best affinity metric (e.g., shortest distance, smallest weight, etc.) with the derived query intent to produce the selected view (i.e., the preferred predefined view). For example, suppose that the view selector 122 determines that both of VIEW 1 and VIEW 2 in FIG. 8 satisfy the particular set of retrieved resources received by the system 100 in response to a resource query (i.e., VIEW 1 and VIEW 2 are the identified predefined views). Further suppose that the intent classifier 120 analyzes the resource query (and optionally the requestor identity) and derives a query intent of INTENT 2. Using the example bi-partite graph illustrated in FIG. 9, the view selector 122 checks the edges that link INTENT 2 to VIEW 1 and VIEW 2 to determine the affinity metric between INTENT 2 and VIEW 1, and between INTENT 2 and VIEW 2. In this particular case, the edges of interest are edges 173ba and 173bb. The view selector 122 then selects as the selected view whichever view has a better affinity metric, i.e., the view selector 122 selects VIEW 1 if the edge 173ba represents a better affinity metric (e.g., shorter distance, smaller weight, etc.) than the edge 173bb, and selects VIEW 2 if the edge 173bb represents a better affinity metric (e.g., shorter distance, smaller weight, etc.) than the edge 173ba.

It is noted that in certain embodiments the graphs module 126 may provide a single graph to the view selector 122 that combines the graph of FIG. 7 together with the bi-partite graph.

In certain embodiments, the set of predefined views preferably contains a generic predefined view that is satisfied by any set of retrieved resources. Such a generic predefined view serves as a fallback view in situations in which, for example, i) a more suitable view that represents a set of retrieved resources is not identified/selected by the view selector 122, and/or ii) a more suitable view that represents a set of retrieved resources does not exist in the system 100. The generic predefined view is preferably represented by a separate node in the intent2view graph connected to all of the predefined query intents but with less favorable affinity metrics (e.g., a predefined maximum distance/weight). Turning back to FIG. 9, if, for example, VIEW 5 represents the generic predefined view, the metric associated with the edge 173ae would be less favorable than the metrics associated with the edges 173aa, 173ab, 173ac and 173ad, such that only if a more suitable view associated with INTENT 1 is not identified or does not exist would the view selector 122 select VIEW 5 if the derived query intent is INTENT 1. Similarly, the metric associated with the edge 173be would be less favorable than the metrics associated with the edges 173ba, 173bb, 173bc and 173bd, such that only if a more suitable view associated with INTENT 2 is not identified or does not exist would the view selector 122 select VIEW 5 if the derived query intent is INTENT 2. Similarly, the metric associated with the edge 173ce would be less favorable than the metrics associated with the edges 173ca, 173cb, 173cc and 173cd, such that only if a more suitable view associated with INTENT 3 is not identified or does not exist would the view selector 122 select VIEW 5 if the derived query intent is INTENT 3.

The representation generator 128 is configured to receive from the view selector 122 an identified predefined view that is satisfied by the set of retrieved resources, and in particular preferably receives the selected (i.e., preferred) view from the view selector 122. The representation generator 128 preferably also receives as input the set of retrieved resources from the query executor 116, as well as the requestor identity from the frontend interface 110 and the derived query intent from the intent classifier 120. The representation generator 128, in response to receiving the above-mentioned inputs, is configured to generate a representation of the set of retrieved resources according to a particular one of the predefined views (i.e., one of the identified predefined views), and in particular according to the selected view, so as to render a view of the set of retrieved resources according to the particular predefined (selected) view.

The representation is achieved by recursively generating the representation of the selected view through the respective display components, frontend types and frontend attributes. The recursive generation may operate in a layered manner, by which a representation of each of the display components of the selected view is generated. Then, for each generated representation of a display component, representations of the frontend types of the display component are generated. Then, for each generated representation of a frontend type, representations of the frontend attributes are generated. The representations of the frontend attributes are generated by applying the relevant predefined transformation to the associated backend attribute so as to map the associated backend attribute to the corresponding frontend attribute.

In certain preferred embodiments, before generating the representation of each display component, the representation generator 128 checks if the display component includes one or more display conditions. If any such display conditions are present, the representation generator 128 checks whether one or more of the display conditions are satisfied (i.e., if at least one of the display conditions is satisfied). If one or more of the display conditions is satisfied, the representation generator 128 generates a representation of the display component (and subsequently the representations of the frontend types and frontend attributes of that display component). If none of the display conditions are satisfied, the representation generator 128 does not generate a representation of the display component.

As previously mentioned, the display conditions may be based on the requestor identity and/or the derived query intent. One non-limiting example of a display condition could be to render different display components based on the user role, since users of different roles have a need to view different data. For example, a security operator user likely needs to view data that is different from the data that a compliance officer user needs to view. Another non-limiting example of a display condition could be to render a display component based on the security clearance level associated with the requestor identity. It is also noted herein that the query intent derived from the resource query may vary between simple intents (e.g., “resources accessible to X and that were not accessed by X in the last 3 months”) and more complex intents (e.g., “users with administrative access to X that do not have access to Y”). Certain more complex intents may require logical comparisons between three different components (referred to as trinary context). One example of a trinary context query intent could be “all entitlements granting access to more than 10 resources for more than 10 users and providing the permission to modify”, where the trinary context is the number of resources, the number of users, and the type of role. As should be apparent, even more complicated query intents are contemplated herein, based on, for example, more than three components (i.e., greater than trinary context).

The representation generator 128 provides the generated representation of the set of retrieved resources (according to the selected view) to the result output interface 114, which may then output the representation of the retrieved set of resources as one or more files or byte stream to be sent to a client computer (such as the client computer 140) over a network, to be written to a file system, an object storage system, or a database (relational or non-relational), or any combination thereof.

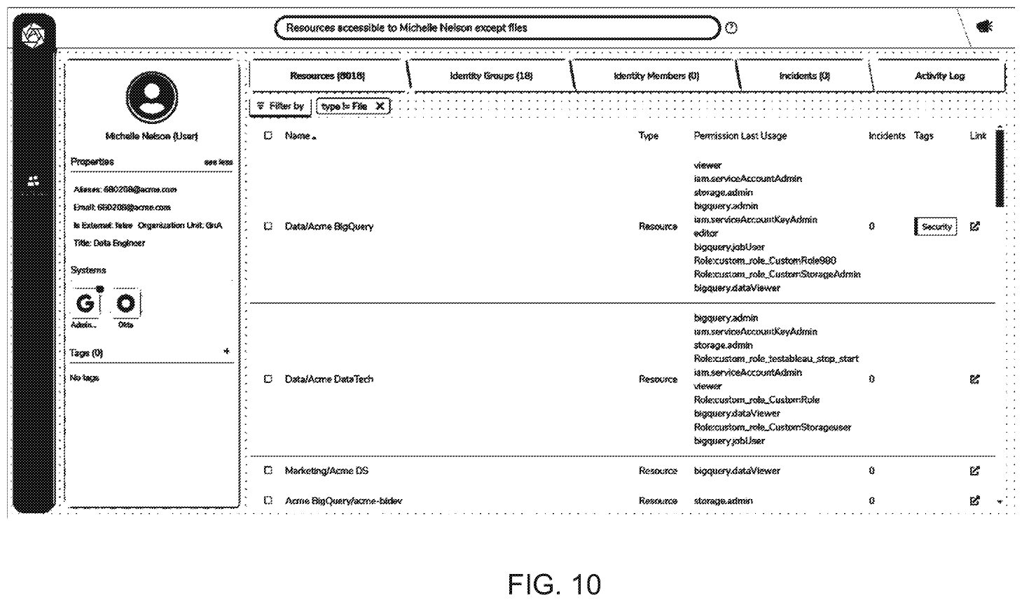

FIG. 10 shows a screenshot of a non-limiting example of a representation of a set of retrieved resources that is generated by the representation generator 128 according to a selected view. In this particular non-limiting example, the representation is a visual representation which can be viewed on a computer display, such as the display of client computer 140. The selected view includes multiple display components, including, the filter (type !=File, meaning “no files”), and the columns in the table (i.e., “Name”, “Type” “Permission Last Usage”, “Incidents”, “Tags”, and “Link”). In certain non-limiting implementations, some or all of the boxes in the representation illustrated in FIG. 10, including the editable text box at the top of the screenshot, as well as the tabs below the editable text box (i.e., “Resources”, “Identity Groups”, etc.), is a display component of the selected view. Parenthetically, although the editable text box does not necessarily render information related to the retrieved resources, in certain non-limiting implementations it may nevertheless be as a display component of one (or more) of the predefined views from which the selected view is selected. In this example, the editable text box (editable meaning that a user can edit the text in the text box) serves as an interface for inputting a resource query, which in this example is the resource query “Resources accessible to Michelle Nelson except files”, and therefore the identity of the user is of particular significance. As such, the selected view is selected such that there is provided (as a display component) information pertaining to the permission associated with the resources, the last usage, the resource type, and information identifying the users that have accessed the resource (exemplified by the “Permission Last Usage” column of the table).

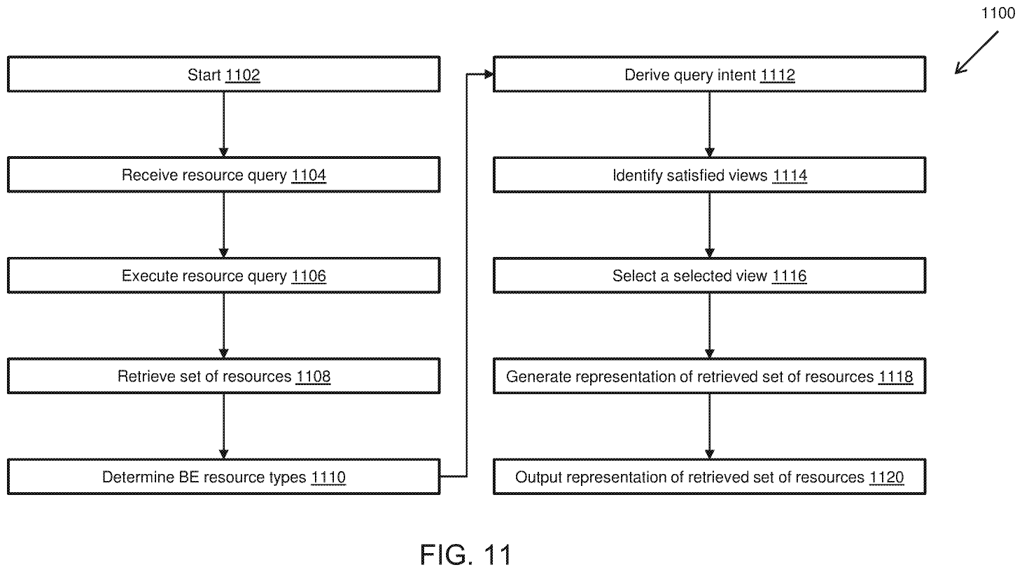

Attention is now directed to FIG. 11 which shows a flow diagram detailing a computer-implemented process 1100 in accordance with embodiments of the disclosed subject matter. This computer-implemented process includes an algorithm for, among other things, identifying satisfied views for query results, selecting a selected view from the satisfied views, and generating a representation of the query results according to the selected view. Reference is also made to the elements shown in FIGS. 1-3 and FIGS. 5-9. The process and sub-processes of FIG. 11 are computerized processes performed by the system 100 including, for example, the CPU 102 and associated components, such as the frontend interface 110 (including the query input interface 112 and the result output interface 114), the query executor 116 (and the backend resource type resolver 118), the intent classifier 120, the view selector 122, the predefined views module 124, the graphs module 126, and the representation generator 128. The aforementioned processes and sub-processes are for example, performed automatically, but can be, for example, performed manually, and are performed, for example, in real time.

At block 1102, the process 1100 starts, where the system 100 is coupled to backend collections of resources 130 and a client computer 140, which in certain embodiments may be via one or more networks. At block 1104, the system 100, and more specifically the frontend interface 110, and more particularly the query input interface 112, receives a resource query that expresses a set of resources that are to be retrieved from at least one backend collection of resources. At block 1106, the query executor 116 receives the resource query from the query input interface 112 and executes the received resource query so as to retrieve (fetch) the set of resources expressed by the resource query from the backend collections of resources.

At block 1108, the query executor 116 retrieves the set of the resources expressed by the resource query from the backend collections of resources. At block 1110, the backend resource type resolver 118 determines, for each retrieved resource in the set of retrieved resources, the backend (BE) resource type associated with the retrieved resource.

At block 1112, the intent classifier 120 analyzes the resource query (received from the query input interface 112), optionally together with the requestor identity (received from the frontend interface 110) to derive a query intent associated with the resource query (and optionally associated with the requestor identity). Block 1112 may be executed contemporaneously with the execution of block 1106, and in certain embodiments blocks 1106 and 1112 are executed simultaneously (i.e., the frontend interface 110 simultaneously provides the resource query to the query executor 116 and the intent classifier 120, and the query executor 116 and the intent classifier 120 respectively execute the resource query and derive the query intent simultaneously).

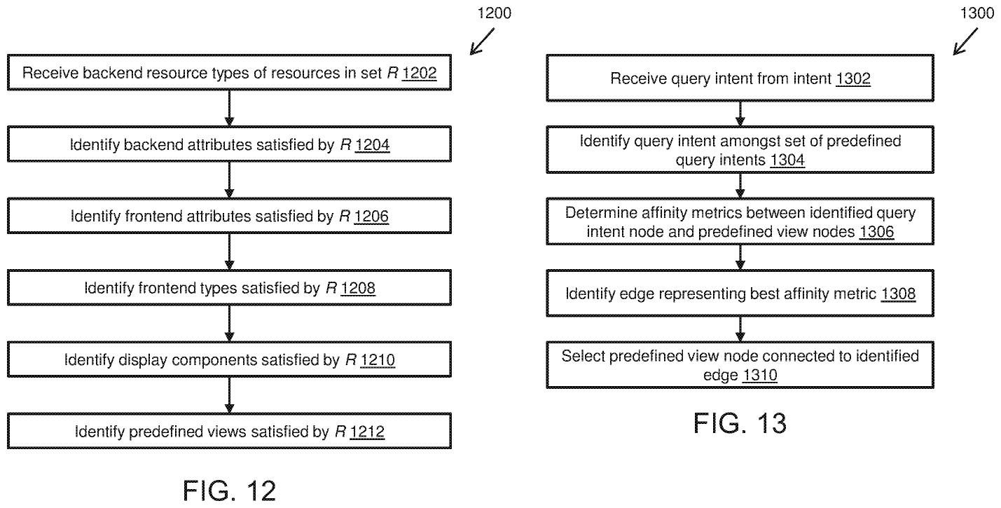

At block 1114, the view selector 122 identifies all of the predefined views that are satisfied by the set of retrieved resources. As discussed above, the view selector 122 may determine which predefined views are satisfied by the set of retrieved resources by employing a graphical model (e.g., the graphical model illustrated in FIG. 7) together with graph theory algorithms/techniques. The determination of satisfied views is based on the set of predefined views, the resource query, the set of retrieved resources, and the backend resource types (determined by the backend resource type resolver 118 at block 1110). The sub-processes of block 1114 are described in detail below in FIG. 12 (process 1200).

At block 1116, the view selector 122 selects a selected view (i.e., a preferred view) from the set of satisfied views identified at block 1114. The selected view is selected based on the derived query intent (derived by the intent classifier 120 at block 1112) and a linking between a set of predefined query intents and the set of predefined views, preferably using a bi-partite graph (e.g., a graphical model on which the example bi-partite graph illustrated in FIG. 9 is based). The sub-processes of block 1116 are described in detail below in FIG. 13 (process 1300).

At block 1118, the representation generator 128 generates a representation of the retrieved set of resources (received from the query executor 116) according to the selected view (selected by the view selector 120 at block 1118). As discussed, the representation generator 128 may recursively generate the representation of the selected view through the respective display components, frontend types and frontend attributes of the selected view. This may include, in some embodiments, checking whether a display component includes one or more display conditions (based on the requestor identity and/or the derived query intent), and checking whether such one or more display conditions are satisfied.

At block 1120 the result output interface 114 receives the generated representation of the set of retrieved resources (according to the selected view) from the representation generator 128, and outputs the representation of the retrieved set of resources as one or more files or byte streams to be sent to a client computer (such as the client computer 140) over a network, to be written to a file system, an object storage system, or a database (relational or non-relational), or any combination thereof.

With continued reference to FIG. 11, attention is also directed to FIG. 12, which shows a flow diagram detailing a process 1200 for identifying all of the predefined views that are satisfied by a set of retrieved resources, as performed by the view selector 122. The steps (blocks) of the process 1200 are representative of the sub-processes of block 1114 of the process 1100. As discussed, the process 1200 may be performed with the aid of a graphical model that provides linking connections between predefined views, display components, frontend types, frontend attributes, backend attributes, and backend types (where the linking connection between frontend and backend attributes is provided by a transformation that maps between frontend and backend attributes).

The process 1200 begins at block 1202, where the view selector 122 receives the backend resource types (of the resources in the retrieved set of resources R) from the backend resource type resolver 118. At block 1204, the view selector 122 identifies the backend attributes that are satisfied by R by determining which backend attributes are part of the backend resource types in R (i.e., a backend attribute is satisfied by R if the backend attribute is part of a backend resource type in R).

At block 1206, the view selector 122 identifies the frontend attributes that are satisfied by R by verifying the existence of (i.e., determining if there is) a mapping between a frontend attribute to a respective backend attribute satisfied by R (i.e., a frontend attribute is satisfied by R if the frontend attribute is mapped to a backend attribute satisfied by R via a transformation).

At block 1208, the view selector 122 identifies the frontend types that are satisfied by R by determining which frontend types have all of their frontend attributes satisfied by R (i.e., a frontend type is satisfied by R if all of the frontend attributes of the frontend type are satisfied by R).

At block 1210, the view selector 122 identifies the display components that are satisfied by R by determining which display components have all of their frontend types satisfied by R (i.e., a display component is satisfied by R if all of the frontend types of the display component are satisfied by R).

At block 1212, the view selector identifies the predefined views in the set of predefined views that are satisfied by R by determining which predefined views have all of their display components satisfied by R (i.e., a predefined view is satisfied by R if all of the display components of the predefined view are satisfied by R).

With continued reference to FIGS. 11 and 12, attention is also directed to FIG. 13, which shows a flow diagram detailing a process 1300 for selecting a selected view (i.e., a preferred view) from the set of satisfied views identified at block 1114 (by the process 1200), as performed by the view selector 122. The steps (blocks) of the process 1300 are representative of the sub-processes of block 1116 of the process 1100. As discussed, the process 1300 may be performed with the aid of a graphical model, in particular a bi-partite graph, that provides linking connections between a set of predefined query intents and the set of predefined views.

The process 1300 begins at block 1302, where the view selector 122 receives the query intent from the intent classifier 120 (derived by the intent classifier 120 from the resource query, and optionally from the requestor identity). At block 1304, the view selector identifies the query intent amongst the set of predefined query intents (for example, the view selector 122 may identify the derived query amongst the nodes representative of the set of predefined query intents in the bi-partite graph).

At block 1306, the view selector 122 determines the affinity metric between the node representative of derived query intent and each node representative of a predefined view satisfied by R (i.e., the nodes representative of the predefined views identified by the process 1200). As discussed, the edges between the predefined query intents and the predefined views represent the value of an affinity metric value (e.g., distance, weight, etc.).

At block 1308, the view selector 122 looks at the edge that connects the node representing each identified predefined view (from block 1306) to the node representing the query intent (from block 1304), and identifies the edge representing the best affinity metric (e.g., shortest distance, smallest weight, etc.). At block 1310, the view selector 122 selects predefined view represented by the node connected to the edge identified at block 1308 as the selected (preferred) view.

It is noted that in general blocks 1114 and 1116 may be combined into a single execution step, whereby the processes 1200 and 1300 (describing the sub-processes of blocks 1114 and 1116) are merged into a single process.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method performed by a computer, the method comprising:
retrieving a set of resources from at least one backend collection of resources in response to a resource query, each resource having an associated backend resource type comprising one or more backend resource attribute;
identifying at least one view from a set of predefined views that is satisfied by the retrieved set of resources, wherein the identifying includes, for each backend resource attribute of the retrieved set of resources, verifying existence of a transformation between the backend resource attribute and a corresponding frontend attribute associated with the at least one view;
selecting a selected view from the identified at least one view based on a query intent derived at least in part from the resource query; and
generating a representation of the retrieved set of resources according to the selected view.

2. The method of claim 1, wherein the identifying at least one view in the set of predefined views that is satisfied by the retrieved set of resources is based on a generated graph that includes:
a first group of nodes representative of the set of predefined views,
a second group of nodes representative of a set of display components associated with some of the predefined views in the set of predefined views,
a third group of nodes representative of a set of frontend types associated with some of the display components in the set of display components,
a fourth group of nodes representative of a set of frontend attributes associated with some of the frontend types in the set of frontend types,
a fifth group of nodes representative of a set of backend resource attributes associated with some of the frontend attributes in the set of frontend attributes via a respective transformation, and
a sixth group of nodes representative of a set of backend resource types including the backend resource type associated with each resource of the retrieved set of resources, the set of backend resource types associated with some of the backend resource attributes in the set of backend resource attributes.

3. The method of claim 1, wherein the identifying at least one view in the set of predefined views that is satisfied by the retrieved set of resources includes determining the existence of at least one linking connection between each of the predefined views in the set of predefined views and the backend resource type associated with each resource of the retrieved set of resources, wherein each predefined view has an associated frontend attribute, and wherein each existing linking connection includes a transformation between each backend resource attribute of the backend resource type and a respective one of the frontend attribute.

4. The method of claim 1, further comprising: analyzing the resource query to derive the query intent.

5. The method of claim 1, wherein the generating the representation of the retrieved set of resources according to the selected view includes:
for each backend resource attribute of the retrieved set of resources, applying the transformation to a value of the backend resource attribute to produce a value of a corresponding frontend attribute, and
generating a representation of at least one display component associated with the frontend attributes.

6. The method of claim 6, wherein the generating a representation of at least one display component associated with the frontend attributes includes:
checking, for each display component, if at least one display condition of the display component is satisfied, and
generating a representation of a particular display component only if at least one display condition of the particular display component is satisfied.

7. The method of claim 1, wherein the at least one backend collection of resources includes a database.

8. The method of claim 7, wherein the database includes a relational database.

9. The method of claim 7, wherein the database includes a non-relational database.

10. The method of claim 1, wherein the at least one backend collection of resources includes an object storage system.

11. The method of claim 1, wherein the at least one backend collection of resources includes a file system.

12. The method of claim 1, further comprising: outputting the generated representation of the retrieved set of resources as at least one of at least one file or at least one byte stream, and wherein the at least one file has a file format including one or more of: Portable Document Format (PDF), spreadsheet format, Hyper Text Markup Language (HTML) format, Extensible Markup Language (XML) format, plaintext format, JavaScript Object Notation (JSON) format, YAML Ain′t Markup Language (YAML).

13. The method of claim 1, further comprising: sending the resource query to one or more backend collection of resources.

14. The method of claim 13, wherein the resource query is sent via a network.

15. The method of claim 1, wherein the resource query is received from a client computer prior to the computer retrieving the set of resources from the at least one backend collection of resources.

16. A computer system coupled to one or more backend collection of resources, the computer system comprising:
a non-transitory computer readable storage medium for storing computer components; and
a computerized processor for executing the computer components, the computer components comprising:
a frontend interface including a query input interface and a result output interface, the query input interface configured to receive a resource query,
a query executor configured to:
receive the resource query from the query input interface, and in response to the received resource query, retrieve a set of resources from at least one of the backend collections of resources, each resource having an associated backend resource type comprising one or more backend resource attribute,
a view selector configured to:
identify at least one view from a set of predefined views that is satisfied by the retrieved set of resources, wherein the identifying includes, for each backend resource attribute of the retrieved set of resources, verifying existence of a transformation between the backend resource attribute and a corresponding frontend attribute associated with the at least one view, and
select a selected view from the identified at least one view based on a query intent derived at least in part from the resource query, and
a representation generator configured to:
generate a representation of the retrieved set of resources according to the selected view, and
provide the generated representation to the result output interface.

17. The computer system of claim 16, wherein the view selector is configured to identify at least one view in the set of predefined views that is satisfied by the retrieved set of resources based on a generated graph that includes:
a first group of nodes representative of the set of predefined views,
a second group of nodes representative of a set of display components associated with some of the predefined views in the set of predefined views,
a third group of nodes representative of a set of frontend types associated with some of the display components in the set of display components,
a fourth group of nodes representative of a set of frontend attributes associated with some of the frontend types in the set of frontend types,
a fifth group of nodes representative of a set of backend resource attributes associated with some of the frontend attributes in the set of frontend attributes via a respective transformation, and
a sixth group of nodes representative of a set of backend resource types including the backend resource type associated with each resource of the retrieved set of resources, the set of backend resource types associated with some of the backend resource attributes in the set of backend resource attributes.

18. The computer system of claim 16, wherein the view selector is configured to identify at least one view in the set of predefined views that is satisfied by the retrieved set of resources by: determining the existence of at least one linking connection between each of the predefined views in the set of predefined views and the backend resource type associated with each resource of the retrieved set of resources, wherein each predefined view has an associated frontend attribute, and wherein each existing linking connection includes a transformation between each backend resource attribute of the backend resource type and a respective one of the frontend attribute.

19. The computer system of claim 16, wherein the computer components further comprise:
an intent classifier configured to:
receive the resource query from the frontend interface,
analyze the resource query to derive the query intent.

20. The computer system of claim 16, wherein the representation generator is configured to generate the representation of the retrieved set of resources according to the selected view by:
for each backend resource attribute of the retrieved set of resources, applying the transformation to a value of the backend resource attribute to produce a value of a corresponding frontend attribute, and
generating a representation of at least one display component associated with the frontend attributes.

21. The computer system of claim 20, wherein the representation generator is configured to generate a representation of at least one display component associated with the frontend attributes by: checking, for each display component, if at least one display condition of the display component is satisfied, and generating a representation of a particular display component only if at least one display condition of the particular display component is satisfied.

22. The computer system of claim 16, wherein the at least one of the backend collections of resources is part of the computer system.

23. The computer system of claim 16, wherein the at least one of the backend collections of resources is separate from the computer system.

24. The computer system of claim 16, wherein the at least one of the backend collections of resources is coupled to the computer system via at least one of a network or an Application Programming Interface (API).

25. The computer system of claim 16, wherein the at least one of the backend collections of resources includes a database.

26. The computer system of claim 25, wherein the database includes a relational database.

27. The computer system of claim 25, wherein the database includes a non-relational database.

28. The computer system of claim 16, wherein the at least one of the backend collections of resources includes an object storage system.

29. The computer system of claim 16, wherein the at least one of the backend collections of resources includes a file system.

30. The computer system of claim 16, wherein the result output interface is configured to:
receive the representation of the retrieved set of resources from the representation generator, and
output the representation of the retrieved set of resources as at least one of at least one file or at least one byte stream, and wherein the at least one file has a file format including one or more of: Portable Document Format (PDF), spreadsheet format, Hyper Text Markup Language (HTML) format, Extensible Markup Language (XML) format, plaintext format, JavaScript Object Notation (JSON) format, YAML Ain′t Markup Language (YAML).

31. The computer system of claim 30, wherein the result output interface is further configured to: provide the at least one file to at least one of: a file system, an object storage system, a database, or a client computer.

32. The computer system of claim 16, wherein the query input interface is further configured to: receive the resource query from a client computer.

33. The computer system of claim 32, wherein the client computer is coupled to the computer system via a network.

34. The computer system of claim 33, wherein the result output interface is configured to:
receive the representation of the retrieved set of resources from the representation generator,
output the representation of the retrieved set of resources as at least one file, and
provide the at least one file to the client computer via the network.

35. A method performed by a computer, the method comprising:
retrieving a set of resources from at least one backend collection of resources in response to a resource query, each resource having an associated backend resource type comprising one or more backend resource attribute;
processing the resource query and the retrieved set of resources to select a selected view from a set of predefined views based at least in part on:
for each backend resource attribute of the retrieved set of resources, at least one transformation that maps the backend attribute to a frontend attribute associated with at least one predefined view in the set of predefined views, and
a query intent, derived at least in part from the resource query, associated with at least one predefined view in the set of predefined view; and
generating a representation of the retrieved set of resources according to the selected view.

36. The method of claim 35, wherein the at least one predefined view associated with the query intent, and the at least one predefined view associated with the frontend attributes, includes the selected view.
